(19) United States
(12) Patent Application Publication
(10) Pub. No.: US 2014/0003617 A1
(43) Pub. Date: Jan. 2, 2014

(54) WIRELESS AUDIO/VIDEO SYSTEM FOR AUDIO SIGNAL REPRODUCTION AND CONTROL METHOD FOR CONTROLLING THE SAME

(71) Applicant: TPV Display Technology (Xiamen) Co., Ltd., (US)

(72) Inventors: Dolin Wang, Xiamen (CN); Bing-Bing Yang, Xiamen (CN); MT Chuang, Xiamen (CN)

(21) Appl. No.: 13/717,314

(22) Filed: Dec. 17, 2012

(30) Foreign Application Priority Data
Jul. 2, 2012 (TW) 101123741

(51) Int. Cl. H04R 3/00

(52) U.S. Cl. CPC H04R 3/00
USPC 381/74

(57) ABSTRACT

A wireless audio/video (A/V) system includes an earphone and an A/V device. The earphone is configured to allow user input of a control command and to transmit the control command. The A/V device is configured to receive a multimedia signal and to extract an audio signal component thereof, to receive the control command from the earphone, and to process the audio signal component accordingly. The A/V device is operable to transmit the processed audio signal component to the earphone for reproduction. The earphone and the A/V device are configured to communicate via a wireless network using Wireless Fidelity (Wi-Fi).

### CROSS-REFERENCE TO RELATED APPLICATION

This application claims priority of Taiwanese Application No. 101123741, filed on Jul. 2, 2012.

### BACKGROUND OF THE INVENTION

1. Field of the Invention

The invention relates to a wireless audio/video system that is for reproducing an audio signal and a control method for controlling the wireless audio/video system.

2. Description of the Related Art

Many conventional terminal systems (e.g., television, computer, handheld device, etc.) are configured to wirelessly transmit an audio signal to a far-end device (e.g., an earphone) for reproducing the same. Conventionally, the audio signal is transmitted using Bluetooth technology. However, using Bluetooth has some drawbacks. For example, Bluetooth is designed for data exchange within a short distance, therefore reducing convenience for a user of the far-end device. Additionally, establishing and setting a connection between two devices using Bluetooth may be relatively inconvenient and time-consuming.

Moreover, the conventional terminal system is not available to fulfill the occasion in which there are more than one user using the conventional terminal system at the same time and each of the users has a different request (e.g., one user holding the earphone for listening to radio, while another user is watching television).

### SUMMARY OF THE INVENTION

Therefore, one object of the present invention is to provide a wireless audio/video (A/V) system that is able to ameliorate the aforementioned drawbacks.

Accordingly, a wireless A/V system of the present invention is for playing an audio signal. The wireless A/V system comprises an earphone and an A/V device.

The earphone includes a controller module, a communication interface and an audio reproducing module. The controller module is for allowing user input of a first control command. The communication interface is for transmitting the first control command with electromagnetic wave.

The A/V device includes a signal receiving module, a signal processing module and an audio outputting module. The signal receiving module is for receiving a multimedia signal from an external multimedia source, and for extracting an audio signal component of the multimedia signal. The signal processing module is for receiving the first control command from the communication interface of the earphone, and for processing the audio signal component according to the first control command. The audio outputting module is coupled wirelessly to the audio reproducing module for transmitting the audio signal component processed by the signal processing module to the audio reproducing module via a wireless network, so as to be reproduced by the audio reproducing module. Preferably, the audio reproducing module of the earphone and the audio outputting module of the A/V device are configured to communicate with the wireless network using Wireless Fidelity (Wi-Fi).

Another object of the present invention is to provide a control method for controlling the abovementioned wireless A/V system.

The wireless A/V system is configured for playback of an audio signal, and includes an earphone and an A/V device. The A/V device is configured to receive a multimedia signal from an external multimedia source and to extract an audio signal component of the multimedia signal. The control method comprises the following steps of:

(A) coupling the earphone to the A/V device through a wireless network, wherein the earphone and the A/V device are configured to use Wireless Fidelity (Wi-Fi) to communicate with the wireless network;

(B) configuring the earphone to allow user input of a first control command;

(C)upon receiving the first control command, configuring the earphone to transmit the first control command with electromagnetic wave;

(D) when the A/V device receives the first control command, configuring the A/V device to process the audio signal component according to the first control command; and

(E) configuring the A/V device to transmit the audio signal component processed thereby to the earphone via the wireless network, so as to be reproduced by the earphone.

### BRIEF DESCRIPTION OF THE DRAWINGS

Other features and advantages of the present invention will become apparent in the following detailed description of the preferred embodiment with reference to the accompanying drawings, of which:

FIGS. 1A and 1B are schematic block diagrams of a preferred embodiment of a wireless audio/video (A/V) playing system according to the invention;

FIG. 2 is a flowchart of a set-up procedure of an A/V device and an earphone of the wireless A/V system;

FIG. 3 is a flowchart of a remote control procedure, in which a user uses the earphone to control the A/V device; and

FIG. 4 is a flowchart of a near-end control procedure, in which a user controls the A/V device at near end.

### DETAILED DESCRIPTION OF THE PREFERRED EMBODIMENT

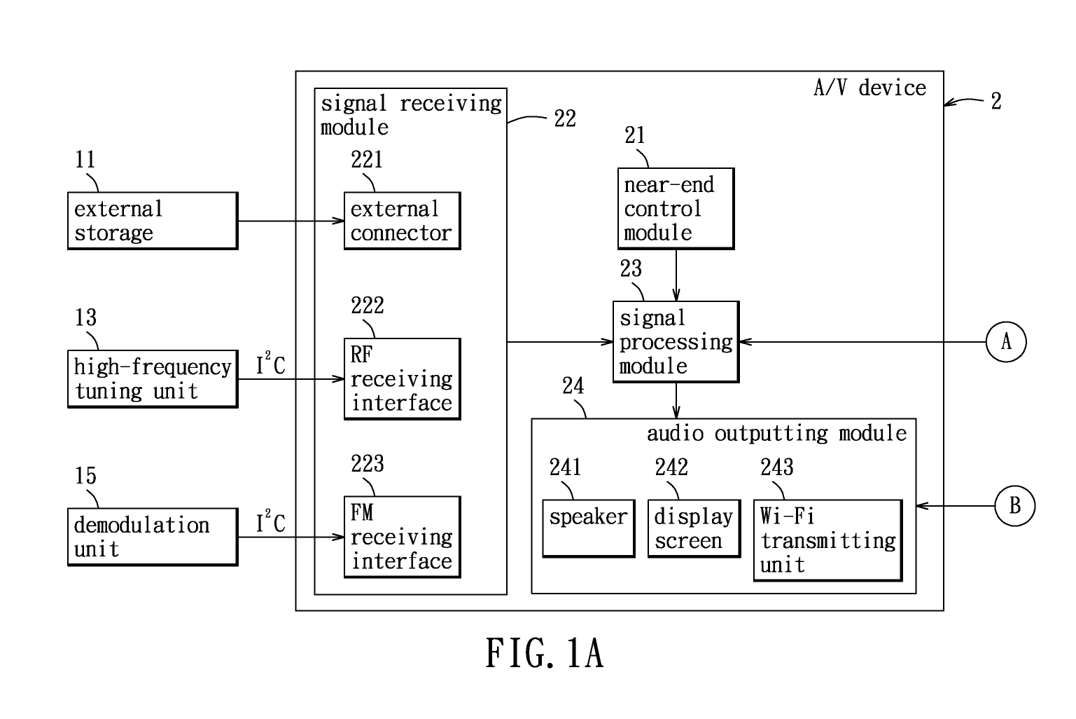

FIGS. 1A and 1B show the preferred embodiment of a wireless audio/video (A/V) playing system according to the present invention. The wireless A/V system is configured to receive a plurality of multimedia signals from respective ones of external multimedia sources. In some examples, the multimedia signals may include at least one of a multimedia file stored in an external storage medium (e.g., a flash drive), a television signal, and a radio signal. The wireless A/V system is further configured to provide an audio signal component, which is extracted from one of the multimedia signals, to a user.

The wireless A/V system comprises an A/V device 2 and an earphone 3. The A/V device 2 can be, for example, one of a digital television (DTV), a closed-circuit TV, a personal computer, a smart phone, etc. Preferably, the A/V device 2 has a TV function.

The earphone 3 is coupled to the A/V device 2 through a wireless network, and includes a controller module 31, a communication interface 32 and an audio reproducing module 33. The controller module 31 allows user input of a first control command. In some examples, the first control command instructs the wireless A/V system to perform one of the following: activating the earphone 3, activating on the A/V device 2, reproducing the audio signal, pausing the audio signal, turning up/down the volume, switching to previous/next track/channel, switching to another one of the multimedia signals, etc. The communication interface 32 is for transmitting the first control command with electromagnetic wave. In some examples, the communication interface 32 may include at least one of an Infrared communication unit 321 and a Bluetooth communication unit 322 for transmitting the first control command. The audio reproducing module 33 includes a Wi-Fi receiving unit 331 and a speaker 332.

The A/V device 2 includes a near-end control module 21, a signal receiving module 22, a signal processing module 23 and an audio outputting module 24. In this embodiment, the audio reproducing module 33 of the earphone 3 and the audio outputting module 24 of the A/V device 2 are configured to communicate with the wireless network using Wireless Fidelity (Wi-Fi).

Using a Wi-Fi for transmitting the audio signal can be beneficial in a number of aspects. For example, Wi-Fi is designed for data transmission within a broader range (i.e., 100 meters), so as to grant relatively greater convenience for the user. Since Wi-Fi supports faster and more stable data transmission, the A/V device 2 can provide the earphone 3 with both a better quality and higher stability. Moreover, data transmission using Wi-Fi has a relatively low signal strength (and therefore, lower radiated power) and should be less harmful to the user than an average cell phone, which has a higher signal strength.

The near-end control module 21 allows user input of a second control command. In some examples, the second control command is inputted by another user that is different from the user of the earphone 3. The signal receiving module 22 is for receiving the multimedia signal components from the external multimedia sources, and for extracting audio signals respectively from the multimedia signals. In this embodiment, the signal receiving module 22 includes an external connector 221, a radio frequency (RF) receiving interface 222, and a frequency modulation (FM) receiving interface 223. The external connector 221 is configured for connection to the external storage medium so as to access the multimedia file(s) stored in the external storage medium. In some examples, the external connector 221 is a universal serial bus (USB) 3.0 interface. The RF receiving interface 222 is for receiving the television signal. The FM receiving interface 223 is for receiving the radio signal. In this embodiment, each of the RF receiving interface 222 and the FM receiving interface 223 is a serial communication bus, e.g., an inter-integrated circuit (I²C) computer bus.

In this embodiment, the external multimedia sources include an external storage 11 (e.g., a USB flash drive) connected to the external connector 221, a high-frequency tuning unit 13 connected to the RF receiving interface 222, and a demodulation unit 15 connected to the FM receiving interface 223. The high-frequency tuning unit 13 and the demodulation unit 15 are operable to receive, process and transmit the television signal and the radio signal to the RF and FM receiving interfaces 222 and 223, respectively. As a result, the external multimedia sources provide the multimedia signals to the signal receiving module 22 simultaneously, and the A/V device 2 is operable to reproduce one of the multimedia signals, and the signal receiving module 22 is operable to extract the audio signal components from the multimedia signals, respectively.

The signal processing module 23 is operable to receive the first control command from the communication interface 22, and to select and process one of the audio signal components according to the first control command. In this embodiment, the signal processing module 23 is switchable between a single-task mode and a multi-task mode. In the single-task mode, the signal processing module 23 is operable to process one of the first and second control commands. In the multi-task mode, the signal processing module 23 is operable to process both of the first and second control commands concurrently.

For example, when the A/V device 2 is in a standby mode, in which the A/V device 2 is not reproducing any one of the multimedia signals, the signal processing module 23 is switched to the single-task mode. The single-task mode allows the A/V device 2 to provide one of the audio signal components to the earphone 3 even in the standby mode.

On the other hand, when the A/V device 2 is in a play mode, in which the A/V device 2 is reproducing one of the multimedia signals, the signal processing module 23 is switched to the multi-task mode to allow the A/V device 2 to reproduce the desired multimedia signal (e.g., the television signal) and to provide a desired audio signal (e.g., music stored in the USB flash drive) to the earphone 3 concurrently.

The audio outputting module 24 includes a speaker 241 and an optional display screen 242 for reproducing the multimedia signal (which may include both audio and video signal components), and a Wi-Fi transmitting unit 243 for transmitting the processed audio signal component to the Wi-Fi receiving unit 331 of the audio reproducing module 33 of the earphone 3.

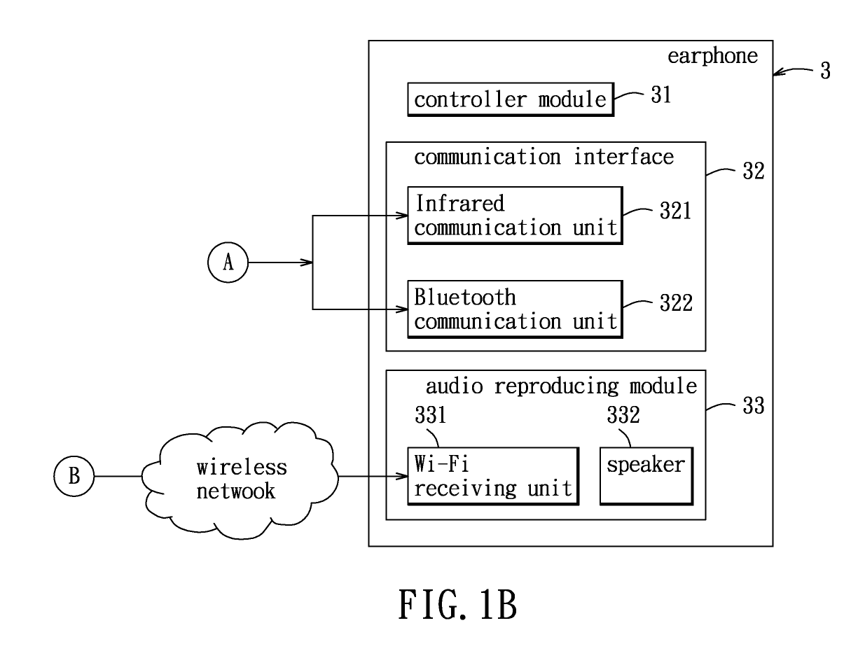

Referring to FIGS. 2 to 4, there is shown the preferred embodiment of a control method for controlling the wireless A/V system for playback of an audio signal. The steps of the control method will now be described in the following.

FIG. 2 illustrates a set-up procedure, in which the A/V device 2 and the earphone 3 exchange necessary information before a Wi-Fi connection is established therebetween for transmitting the processed audio signal component.

Firstly, in step S41, the earphone 3 is activated (i.e., turned on) by the user. The earphone 3 is then operable to transmit a status inquiry to the A/V device 2 in step S42.

The A/V device 2 may be in one of a deactivated state and an activated state, which includes both the standby mode and the play mode. When in the activated state, the signal processing module 23 of the A/V device 2 is operable to, in response to receipt of the status inquiry, transmit to the earphone 3 a status response indicating that the A/V device 2 is in the activated state. The earphone 3 is operable to standby, for a predetermined time (e.g., 10 seconds), to await receipt of the status response in step 43. When the status response is received within the predetermined time, the flow proceeds to step S51. Otherwise, when the earphone 3 does not receive the status response from the A/V device 2 after the predetermined time has elapsed from transmission of the status inquiry, it is deduced by the earphone 3 that the A/V device is in the deactivated state. The flow then proceeds to step S48, in which the earphone 3 is operable to generate and output an audio alert, in order to notify the user that the A/V device 2 is in the deactivated state. In such case, the method is subsequently terminated.

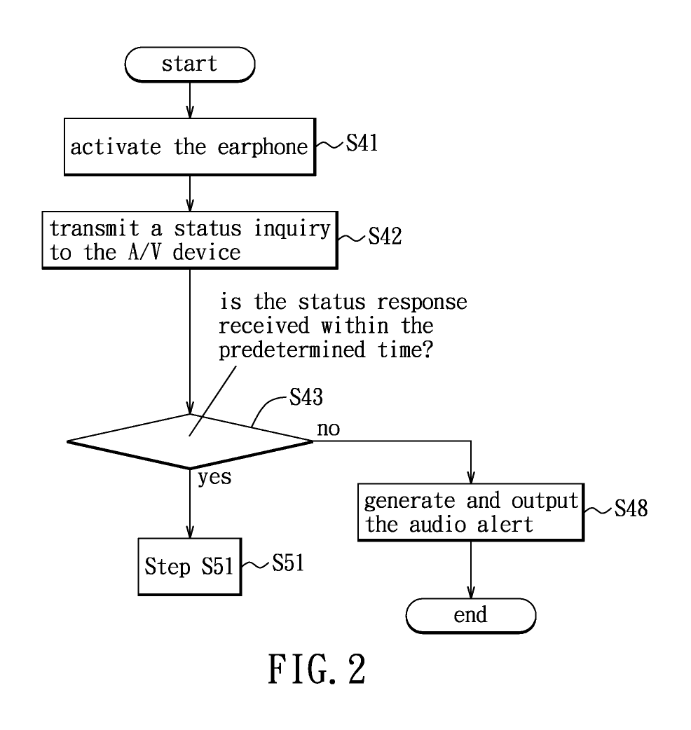

FIG. 3 illustrates a remote control procedure in which the user communicates with the wireless A/V system using the controller module 31 of the earphone 3.

In step S51, the earphone 3 is coupled wirelessly to the A/V device 2. In this embodiment, the audio reproducing module 33 of the earphone 3 and the audio outputting module 24 of the A/V device 2 use Wi-Fi to communicate with the wireless network.

In step S52, the controller module 31 of the earphone 3 is operable to allow the user to input the first control command. Then, in step S53, the first control command is transmitted, with electromagnetic wave, to the signal processing module 23 of the A/V device 2 using the communication interface 32 of the earphone 3. In some examples, the first control command is transmitted using one of the Infrared communication unit 321 and the Bluetooth communication unit 322.

Upon receiving the first control command from the earphone 3, the signal processing module 23 of the A/V device 2 is operable to select and process a desired one of the audio signal component components according to the first control command in step S54. The processed audio signals is then transmitted to the Wi-Fi receiving unit 331 of the audio reproducing module 33 of the earphone 3 via the Wi-Fi transmitting unit 243 through the wireless network, so as to be reproduced by the earphone 3.

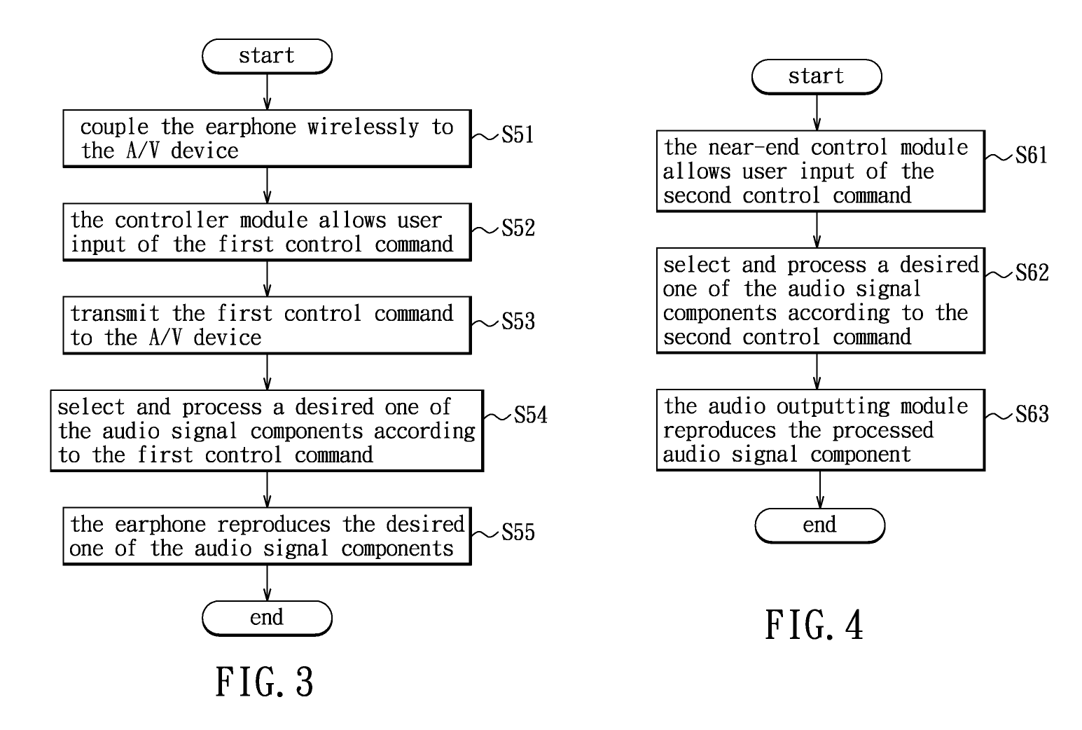

When the A/V device 2 is in the play mode (and thus the signal processing module 23 is in the multi-task mode), the user (and/or another user) is also allowed to control the wireless A/V system using the near-end control module 21 of the A/V device 2 in a near-end control procedure, as illustrated in FIG. 4.

In step S61, the near-end control module 21 of the A/V device 2 allows the user to input the second control command. Upon receiving the second control command from the near-end control module 21, the signal processing module 23 of the A/V device 2 is operable to select and process one of the audio signal components according to the second control command in step S62. The audio outputting module 24 is then operable to reproduce the processed audio signal component in step S63.

To sum up, the controller module 31 of the earphone 3 serves as a remote control of the A/V device 2, and can transmit the first control command to the A/V device 2. According to the first control command, the signal processing module 23 of the A/V device 2 is operable to select one of the audio signal components, which the user desires to be reproduced, from a variety of different external multimedia sources, and to transmit the desired audio signal component to the earphone 3 using Wi-Fi after processing. The user of the earphone 3 can be provided with the desired audio signal component even though he/she is at a relatively large distance from the A/V device 2. Additionally, the signal processing module 23 supports the multi-task mode, and thus, is able to process both the first and the second control commands concurrently, and to provide the desired signals to the audio reproducing module 33 and the audio outputting module 24 respectively. As a result, each of the A/V device 2 and the earphone 3 is able to serve a different demand, making the wireless A/V system more versatile.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A wireless audio/video (A/V) system comprising:
an earphone including
a controller module for allowing user input of a first control command,
a communication interface for transmitting the first control command with electromagnetic wave, and
an audio reproducing module; and
an A/V device including
a signal receiving module for receiving a multimedia signal from an external multimedia source, and for extracting an audio signal component of the multimedia signal,
a signal processing module for receiving the first control command from said communication interface of said earphone, and for processing the audio signal component according to the first control command, and
an audio outputting module coupled wirelessly to said audio reproducing module for transmitting the audio signal component processed by said signal processing module to said audio reproducing module via a wireless network, so as to be reproduced by said audio reproducing module;
wherein said audio reproducing module of said earphone and said audio outputting module of said A/V device are configured to communicate with the wireless network using Wireless Fidelity (Wi-Fi).

2. The wireless A/V system of claim 1, wherein said signal receiving module is configured to receive a plurality of the multimedia signals from respective ones of the external multimedia sources and to extract the audio signal components respectively from the multimedia signals, and said signal processing module is configured to select and process one of the audio signal component according to the first control command.

3. The wireless A/V system of claim 2, wherein said A/V device further includes a near-end control module for allowing user input of a second control command, and said signal processing module is operable to select and process one of the audio signal components according to the second control command, said audio outputting module is operable to reproduce said one of the audio signal components that is selected and processed by said signal processing module according to the second control command.

4. The wireless A/V system of claim 3, wherein said signal processing module is switchable between a single-task mode, in which said signal processing module is operable to process one of the first and second control commands, and a multi-task mode, in which said signal processing module is operable to process both of the first and second control commands concurrently.

5. The wireless A/V system of claim 1, wherein:
upon activating on said earphone, said communication interface of said earphone is operable to transmit a status inquiry to said A/V device; and
when said A/V device is in an activated state, said signal processing module is operable, in response to receipt of the status inquiry, to transmit to said earphone a status response indicating that said A/V device is in the activated state.

6. The wireless A/V system of claim 5, wherein, when said earphone does not receive the status response from said A/V device after a predetermined time has elapsed from transmission of the status inquiry, said audio reproducing module of said earphone is configured to generate and output an audio alert, in order to notify a user that said A/V device is in a deactivated state.

7. The wireless A/V system of claim 1, wherein said communication interface includes at least one of an Infrared communication unit and a Bluetooth communication unit for transmitting the first control command to said signal receiving module of said A/V device.

8. The wireless A/V system of claim 1, the multimedia signal including at least one of a multimedia file stored in an external storage medium, a television signal, and a radio signal, wherein said signal receiving module includes at least one of:
an external connector configured for connection to the external storage medium so as to access the multimedia file stored in the external storage medium;
a radio frequency (RF) receiving interface for receiving the television signal; and
a frequency modulation (FM) receiving interface for receiving the radio signal.

9. A control method for controlling a wireless audio/video (A/V) system that is configured for playback of an audio signal, the wireless A/V system including an earphone and an A/V device that is configured to receive a multimedia signal from an external multimedia source and to extract an audio signal component the multimedia signal, said control method comprising the following steps of:
(A) coupling the earphone to the A/V device through a wireless network, wherein the earphone and the A/V device are configured to use Wireless Fidelity (Wi-Fi) to communicate with the wireless network;
(B) configuring the earphone to allow user input of a first control command;
(C) upon receiving the first control command, configuring the earphone to transmit the first control command with electromagnetic wave;
(D) when the A/V device receives the first control command, configuring the A/V device to process the audio signal component according to the first control command; and
(E) configuring the A/V device to transmit the audio signal to the earphone via the wireless network, so as to be reproduced by the earphone.

10. The control method of claim 9, the A/V device being further configured to receive a plurality of the multimedia signals from respective ones of the external multimedia sources and to extract the audio signal components respectively from the multimedia signals, wherein in step (D), the A/V device is configured to select and process one of the audio signal components according to the first control command.

11. The control method of claim 10, the A/V device being further configured to allow user input of a second control command, said control method further comprising the following step of:
configuring the A/V device to select and process one of the audio signal components according to the second control command and to reproduce said one of the audio signal components selected and pressed accordingly to the second control command.

12. The control method of claim 9, further comprising, before step (A), the following steps of:
(i) configuring the earphone to transmit a status inquiry to the A/V device upon activating on the earphone; and
(ii) when the A/V device is in an activated state, configuring the A/V device to, in response to receipt of the status inquiry, transmit to the earphone a status response indicating that the A/V device is in the activated state.

13. The control method of claim 12, further comprising, after step (i), the following step of:
when the earphone does not receive the status response from the A/V device after a predetermined time has elapsed from the transmission of the status inquiry, configuring the earphone to generate and output an audio alert, in order to notify a user that the A/V device is in a deactivated state.

14. The control method of claim 11, further comprising the step of switching the A/V device between a single-task mode, in which the A/V device is operable to process one of the first and second control commands, and a multi-task mode, in which the A/V device is operable to process both of the first and second control commands concurrently.
